(19) United States
(12) Patent Application Publication
(10) Pub. No.: US 2016/0371360 A1
(43) Pub. Date: Dec. 22, 2016

(54) TERMINAL FOR DISPLAYING ELEMENTS OF A DATABASE HIERARCHIZED IN N LEVELS

(71) Applicant: THALES, Neuilly Sur Seine (FR)

(72) Inventors: Patrick CHORIN, BREST CEDEX 3 (FR); Yves DURIEUX, BREST CEDEX 3 (FR); Olivier GRISVARD, BREST CEDEX 3 (FR); Eric LE PORS, BREST CEDEX 3 (FR)

(73) Assignee: THALES, Neuilly Sur Seine (FR)

(21) Appl. No.: 15/101,727

(22) PCT Filed: Dec. 5, 2014
(86) PCT No.: PCT/EP2014/076745

§ 371 Date: Sep. 13, 2016

(30) Foreign Application Priority Data
Dec. 5, 2013 (FR) 13 02837

(51) Int. Cl. G06F 17/30; G06F 3/0484

(52) U.S. Cl. CPC G06F 17/30589; G06F 17/30572; G06F 17/30958; G06F 3/04842

(57) ABSTRACT

The invention relates to a display terminal for elements of a hierarchical database with n levels, at least some of the elements of the database belonging to a same hierarchical level having an association relationship, the terminal including at least two display parts (30, 32, 34). A first part (30) is intended to display a depiction by hierarchical levels of the elements of the database and a second part (32) is intended to display a graphic interaction object (36), having n display activation/deactivation zones (38a-38h), each display activation/deactivation zone (38a-38h) corresponding to a hierarchical level in the first display part (30). The terminal further includes a level filtering module and a display rearrangement module, said display activation/deactivation zones (38a-38h) being accessible to an operator of the terminal to command the level filtering and display rearrangement modules, so as to obtain a selected display depiction of the database. The terminal further includes means for selecting a central display level, the display of the selected central display level not being able to be deactivated via said activation/deactivation zones (38a-38h).

The present invention relates to a terminal for displaying elements of a database hierarchized in n levels.

The invention falls within the field of displaying elements from a relational database, comprising elements connected according to several hierarchical levels.

The invention is in particular applicable in the field of displaying technical elements of a technical database used in a mission system.

A mission system allows one or more operators to carry out a given mission, for example an environment surveillance, reconnaissance or combat mission, using a situation analysis system including various sensors (e.g., radars, cameras, detectors) and/or effectors (e.g., scramblers, decoys). The mission system aggregates many pieces of information provided by the various sensor systems to provide a synthetic view to the operator, via a man-machine interface (MMI). Furthermore, the mission system is able to present the operator with information of various types, for example information relative to the onboard sensors/effectors or information relative to the monitored targets or objects, from knowledge databases.

Such mission systems are in particular intended to be onboard a carrier (e.g., aircraft, land vehicle, ship).

The tree structure of the information or technical elements to be displayed is complex, the objects having several types of relationships to one another, i.e., hierarchical relationships, and association relationships on a same hierarchical level. For example, information relative to the sensors, the detected signals, the parameters associated with the various sensors and the detected signals are presented, the detected signals each being related to a given sensor, and being able to have connections to one another on a same hierarchical level.

In general, it will be noted that the elements to be presented are numerous and complex, and have several types of relationships, and several elements can be associated with a same hierarchical level.

In particular, in the field of the use of mission systems, an operator needs to understand a set of information easily and very quickly, so as to be able to react quickly.

Traditionally, the elements of a database with several hierarchical levels are presented in the form of a list-type tree structure in table form with indentations to indicate several hierarchical levels, similar to file browsers in an operating system.

However, such a depiction, called a tree structure, only makes it possible to show a single type of relationship between elements, i.e., a hierarchical relationship, without allowing the depiction of connections between the elements of a same hierarchical level. Furthermore, when many elements are present, an operator risks losing time looking for elements of interest at various depths levels in the tree structure.

There is therefore a need to improve the display of relational database elements, the elements of which also have more complex relationships than a tree structure where each element has only one parent, in particular in this context of use in a mission system.

To that end, according to a first aspect, the invention proposes a display terminal for elements of a hierarchical database with n levels, at least some of the elements of the database belonging to a same hierarchical level having an association relationship, the terminal including at least two display parts. The terminal is such that the first part is intended to display a depiction by hierarchical levels of the elements of the database and a second part is intended to display a graphic interaction object, having n display activation/deactivation zones, each display activation/deactivation zone corresponding to a hierarchical level in the first display part, the terminal including a level filtering module and a display rearrangement module, said display activation/deactivation zones being accessible to an operator of the terminal to command the level filtering and display rearrangement modules, so as to obtain a selected display depiction of the database. The terminal further includes means for selecting a central display level, the display of the selected central display level not being able to be deactivated via said activation/deactivation zones.

Advantageously, owing to the graphic interaction object, having n display activation/deactivation zones, each zone corresponding to a hierarchical level in the first display part, the operator has the possibility of dynamically managing the levels of the tree structure that are viewed, and therefore quickly and easily filtering the levels to be displayed, while having a guarantee that a central display level will be displayed.

The display terminal according to the invention may also have one or more of the features below, considered independently or in combination:
the graphic interaction object includes a displayed level indicator, accessible to the operator to modify the number of levels displayed around the central display level;
the terminal includes means for selecting a central display element, and the hierarchical level to which the central display element belongs is designated as central display level;
the terminal further includes a third display part able to display attributes relative to said central display element;
the display rearrangement module is able to update the displayed elements and the display of the graphic interaction object as a function of the central display level selected by the operator;
the elements of the database are depicted in hierarchical graph form, elements of the same hierarchical level being depicted on a same level of said hierarchical graph, elements of a current hierarchical level being connected to one or several elements of the level above the current level and to one or several elements of the level below the current level;
at least some display activation/deactivation zones of the graphic interaction object are associated with corresponding hierarchical sub-levels.

According to a second aspect, the invention proposes a method for displaying elements of a hierarchical database with n levels, at least some of the elements of the database belonging to a same hierarchical level having an association relationship, the terminal including at least two display parts, a first part being intended to display a depiction by hierarchical levels of the elements of the database and a second part being intended to display a graphic interaction object, having n display activation/deactivation zones, each zone corresponding to a hierarchical level in the first display part (30). The method includes the following steps:
receiving a selection command of a central display level,
receiving an operator selection command of an activation/deactivation zone,
verifying (82) the association of the selected activation/deactivation zone with the central display level,
in case of negative verification, obtaining a hierarchical level p associated with said selected activation/deactivation zone,
modifying the depiction by hierarchical levels of the database by filtering or adding the hierarchical level p associated with said selected activation/deactivation zone.

According to one feature, the display method includes, after the step for obtaining a hierarchical level, the following steps:
verifying a display activation state associated with said selected activation/deactivation zone,
in case of activated state, filtering the displayed elements with hierarchical level p and calculating the links between the elements of a parent level of hierarchical level p and the elements of a child level of hierarchical level p,
in case of deactivated state, selecting elements of the hierarchical level p to be displayed.

According to one particular feature, the display method further includes a step for updating the display of the activation/deactivation zones for the graphic interaction object.

According to one feature, the display method further includes steps, implemented following the reception of a selection command for the central display level, of:
updating the depiction by hierarchical levels of the database elements, and
updating a displayed level indicator associated with the graphic interaction object as a function of the selected central display level.

According to another particular feature, the method further includes the following steps:
receiving a selection command for a central display element,
selecting the hierarchical level to which the central display element selected as central display level belongs,
updating the depiction by hierarchical levels of the database elements as a function of the selected central display level, and
updating a displayed level indicator associated with the graphic interaction object as a function of the selected central display level.

Other features and advantages of the invention will emerge from the description thereof provided below, for information and non-limitingly, in reference to the appended figures, in which:

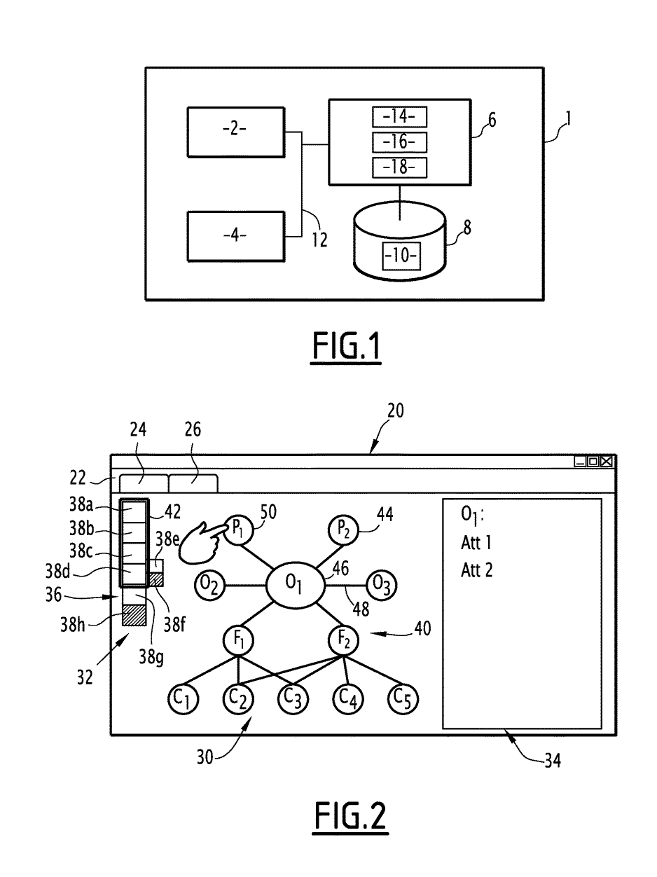

FIG. 1 is a block diagram illustrating a display terminal according to one embodiment of the invention;

FIG. 2 diagrammatically illustrates a first display state of elements of a relational database according to one embodiment of the invention;

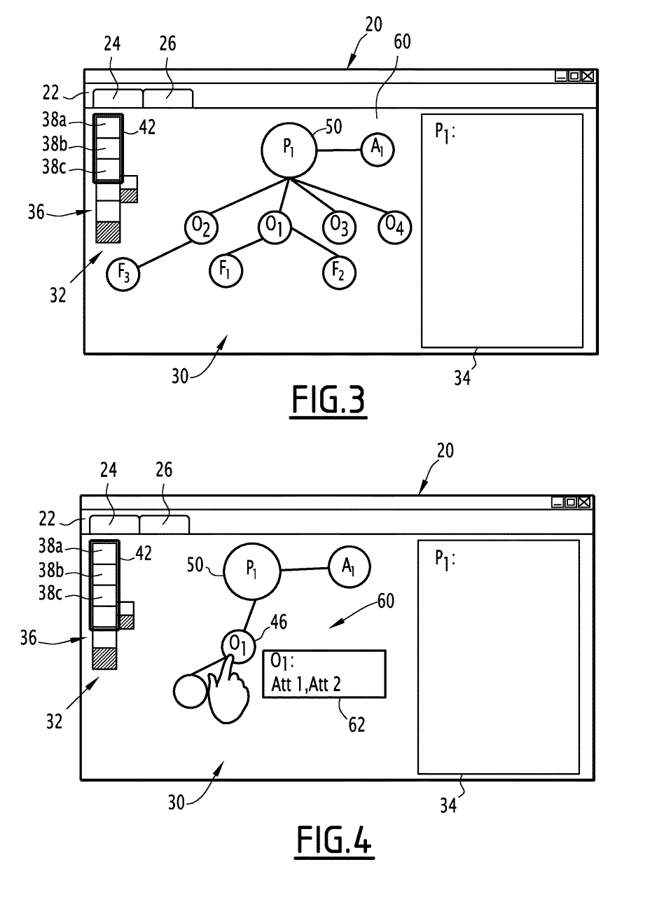

FIG. 3 diagrammatically illustrates a second display state of the elements of FIG. 2 following an operator command;

FIG. 4 diagrammatically illustrates a third display state of the elements of FIG. 2 following an operator command;

FIG. 5 diagrammatically illustrates a fourth display state of the elements of FIG. 2 following an operator command;

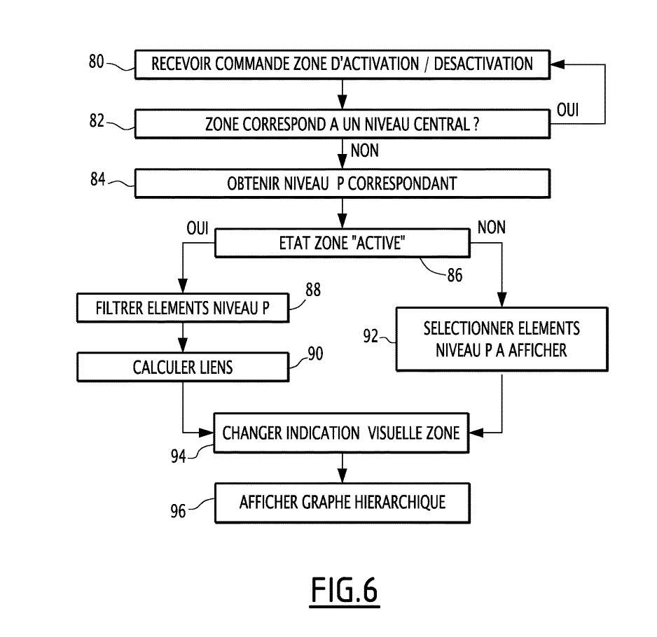

FIG. 6 illustrates the main steps of a method for displaying elements from a hierarchical database with n levels according to one embodiment of the invention;

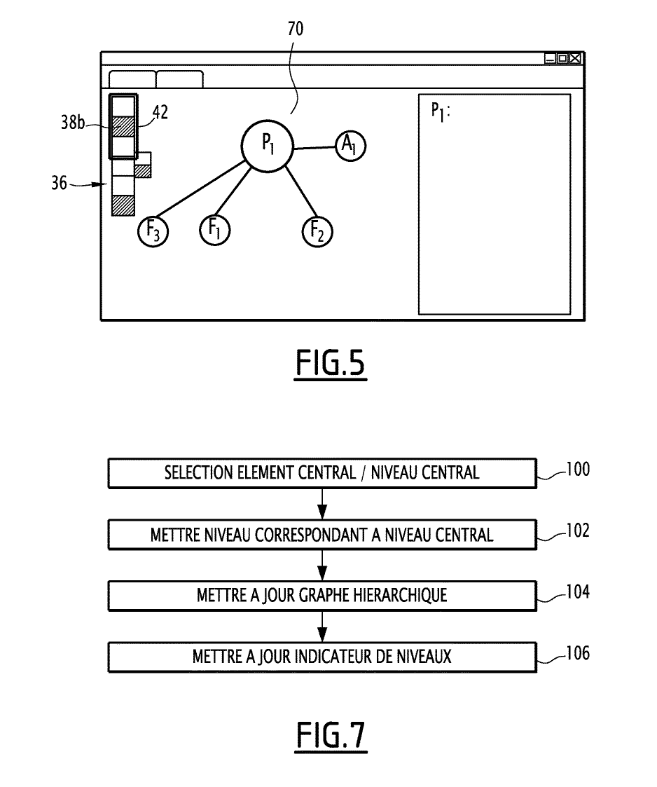

FIG. 7 illustrates the main steps of an element/central level display method according to one embodiment of the invention.

The invention will be described below more particularly as it applies to a mission system, including a display terminal able to display elements of a relational database with n hierarchical levels.

FIG. 1 diagrammatically shows a block diagram illustrating a display terminal 1 according to one embodiment of the invention.

The display terminal 1 comprises a display screen 2, preferably touch-sensitive, a module 4 for entering commands from an operator, which is for example a touch-sensitive command entry module, making it possible to select graphic elements displayed on a graphic interface of the screen 2, a central processing unit 6, or CPU, able to execute computer program instructions when the display terminal 1 is powered on.

The central processing unit 6 is in communication with information storage means 8, for example registers, able to store executable code instructions and parameter values for implementing programs including code instructions able to carry out the method according to the invention.

A relational database 10 with n hierarchical levels, some elements of which are also connected by at least one association relationship of a type other than the hierarchical relationship, is stored in the information storage means 8.

The various functional blocks of the display terminal 1 described above are connected using a communication bus 12.

The central processing unit 6 implements a level filtering module 14, a display rearrangement module 16 and a selection module 18 able to implement means for selecting a central display level and/or a central display element.

FIG. 2 diagrammatically shows a graphic interface 20 of a display screen 2 of an operator terminal 1 according to one embodiment of the invention.

The graphic interface 20 of FIG. 2 is in a first display state.

A display window 22 is shown, including several selectable tabs 24, 26, each selectable tab corresponding to a display view of the relational database 10 to be displayed.

In the example of FIG. 2, the tab 24 is selected, for a display according to a display mode in graph form of the elements of the relational database.

In the embodiment of FIG. 2, the window 22 includes three parts, respectively denoted 30, 32, 34. The first part 30 is intended to display a depiction by hierarchical levels of the database elements. The second part 32 is intended to display a graphic interaction object 36, having n=8 selectable display activation/deactivation zones, referenced 38a to 38h.

In the example of FIG. 2, a hierarchical graph 40 is displayed in the first part 30 of the display window 22, this hierarchical graph 40 depicting four hierarchical levels among the eight hierarchical levels of the database 10.

The graphic interaction object 36 includes a level indicator 42, which is a rectangular box with thick lines of a set of activation/deactivation zones 38a to 38h in the example of the figure, making it possible to visually depict the hierarchical levels actually displayed, following a selection by the operator. Each hierarchical level has an associated display activation/deactivation zone. In the example of FIG. 2, the zone 38a corresponds to hierarchical level 1 of the database 10, the zone 38b corresponds to hierarchical level 2, the zone 38c corresponds to hierarchical level 3, and so forth.

According to one embodiment, a corresponding hierarchical level is displayed directly in the activation/deactivation zones 38a to 38h.

Alternatively, other types of correspondence indications are displayed, for example a color correspondence between the hierarchical levels and the display activation/deactivation zones 38a to 38h, for example by a textual annotation.

It should be noted that the total number of hierarchical levels of the database is n=8, therefore the graphic interaction object comprises eight activation/deactivation zones.

Furthermore, level 4 includes two sub-levels, sub-level 5 and sub-level 6. A hierarchical level corresponds to a type of element, and a sub-level comprises a sub-type of elements of the type of elements of the parent level. For example, when level 4 corresponds to a “vehicle” type, the two sub-levels 5 and 6 respectively correspond to “2-wheeled vehicle” and “4-wheeled vehicle”.

For example, in the context of a mission system, the elements of a hierarchical level of the database represent a boat weapon system made up of radars and optical sensors, the three sub-levels in question being the weapons, the active sensors and the passive sensors.

Subsequently, to simplify the explanation, mention will simply be made of hierarchical levels, each level being associated with an activation/deactivation zone of the graphic interaction object 36.

The activation zones have a current “activated” or “deactivated” display state, corresponding to the hierarchical graph 40 displayed in the current display state.

The activation/deactivation zones corresponding to levels 6 and 8 have an associated visual indicator, for example shown crosshatched, indicating a deactivation state. All of the elements of the hierarchical levels associated with the deactivated levels are filtered, and therefore not shown, in the hierarchical graph 40.

The hierarchical graph 40 includes elements or objects 44, depicted around a central display object 46, or central element, selected by the operator. The central element in this example is labeled O₁. A visual indicator is used to indicate the displayed central element. In the embodiment illustrated in FIG. 2, the element 46 is larger than the other displayed elements. Alternatively, the shape of the graphic icon representing the central element is chosen to be different from the shape of the graphic icons representing the other elements, the difference being a difference in geometric shape or a difference indicated by an additional marking. In general, any visual indicator means making it possible to distinguish the central element easily can be used.

The other two elements, labeled O₂ and O₃, of the same hierarchical level are linked to the central element 46. The association is depicted by links 48.

Furthermore, attributes of the central element 46 are displayed in the third part 34 of the display window 22.

The central element 46 is part of hierarchical level 2, which is the central display level. The level indicator 42 is positioned relative to the central display level. For example, in FIG. 2, four levels are displayed, positioned relative to level 2. The expression N<level number>(−<value above>+<value below>) is used to encode the position of the level indicator 42.

Thus, in the example of FIG. 2, the level indicator 42 can be coded by:

N2(−1,+2).

The central display level cannot be deactivated by the corresponding display activation/deactivation zone 38b.

Consequently, when a level is displayed as central level, the corresponding activation/deactivation zone is frozen in an “activated” state and cannot be controlled by the operator.

In one embodiment, the activation/deactivation zone of the graphic interaction object includes a visual indication making it possible to indicate to the operator that it is associated with the central display level, for example by a color indication or by a particular fill texture.

Thus, at least one level of the hierarchical graph 40 is displayed, i.e., the central level, which cannot be deactivated. One or several levels around the central level, either situated above or below, or both, as in the example of FIG. 2, are displayed. The hierarchical levels situated above the central level are called parent levels, and the hierarchical levels situated below are called child levels. As illustrated in FIG. 2, an element of a hierarchical level may have several parent elements in the level directly above, such as the elements C₂ and C₃.

An operator can act directly on the level indicator 42, by a predetermined command such as a translational movement while keeping a finger pressed on a point of that indicator 42, in order to command an increase or decrease in the number of levels displayed in the hierarchical graph 40.

For example, if, from the example of FIG. 2, an operator extends the indicator 42 so as to encompass levels 5 and 6, the command actuates the display rearrangement module 16, which includes, in the display, the elements of the selected level 5, which is in the “activated” state, relative to the current central display element.

According to a first embodiment, level 6, which is in the “deactivated” state according to the corresponding activation/deactivation zone 38f, is displayed crosshatched.

According to a second embodiment, a command from an operator selecting additional hierarchical levels to be displayed automatically causes, by the implementation of the filtering module 14 and the rearrangement module 16, an activation of all of the selected levels, their display, and an update of the corresponding activation/deactivation zones 38.

When the display screen 2 is a touch-sensitive screen, the operator may select another element as central element by simply clicking with a finger.

Alternatively, if the screen is not touch-sensitive, a pointing means is used to select another central display element.

For example, if the operator selects the element 50, labeled P₁, the rearrangement module 16 of the graphic display is implemented. The element P₁ becomes the central element, therefore the icon representing it is modified, for example enlarged, as illustrated in FIG. 3, while the graphic icon representing the previous central element, which is the element 46 in the example of FIG. 2, is returned to a nominal size or shape.

Furthermore, the display rearrangement module 16 automatically re-centers the level indicator 42 relative to the central level associated with the central element. Thus, the level indicator 42 goes from N2(−1,+2) to N1(−1,+2). However, since level 1 is the first level and has no parent level, the level indicator 42 de facto goes to N1(−0,+2). Thus, the number of hierarchical levels displayed automatically goes from four levels to three levels, as illustrated in FIG. 3.

Thus, a depiction 60 of a hierarchical graph including three hierarchical levels, corresponding to a new display state, is obtained.

The third display part 34 is refreshed accordingly with the attributes associated with the central element 50.

Furthermore, a hierarchical graph 60 centered on the central element 50 is displayed. The hierarchical graph 60 is an evolution of the hierarchical graph 40 following the operator's command to select the element 50 as central element. Furthermore, other elements, for example the daughter element F₃ of the element O₂, appear on the hierarchical graph 60.

As illustrated in FIG. 4, when the operator selects an element 46 other than the central element 50 as element of interest, the selection being done by a different command from the selection of the new central element, the filtering module 14, in cooperation with the rearrangement module 16, makes it possible to highlight the branch of the hierarchical graph connecting the selected element of interest 46, the other branches of the graphic depiction 60 being omitted. Furthermore, the attributes of the selected element of interest 46 are displayed in a window 62, positioned near the selected element of interest 46.

Furthermore, the operator can actuate, by touch-sensitive command or by any other available command means, the display activation/deactivation zones 38. For example, a tactile command by prolonged bearing on an activation/deactivation zone is provided to change the activation/deactivation state and to implement the filtering module 14 of the display rearrangement module 16.

For example, when the operator selects the activation/deactivation zone 38b corresponding to hierarchical level 2, the filtering module 14, in cooperation with the rearrangement module 16, implements filtering of all of the elements of hierarchical level 2 and displays a depiction 70 of the hierarchical graph, illustrated in FIG. 5, with only two levels, in which the elements of level 1 are directly connected to the elements of level 3. The filtering module 14 computes the links between level 1 and level 3, so as to display them.

Furthermore, a corresponding visual indicator is displayed on the graphic interaction object 36, at the corresponding activation/deactivation zone 38b. In the illustrated embodiment, the zone 38b is crosshatched to indicate its deactivation.

In the example of FIG. 5, the elements F₁, F₂, F₃ are all linked to the parent element P₁. This is a simplified example, with the understanding that in complex examples, several relationship links between various elements are determined for the display.

If the operator again activates the display activation/deactivation zone 38b, therefore if the display is reactivated, the elements O₁, O₂, O₃ are again displayed with the respective links, therefore the depiction 60 of the hierarchical graph, illustrated in FIG. 3, is displayed again.

Furthermore, the graphic interaction object 36 is modified, the activation/deactivation zone 38b being modified to display an “activated” state of the display of the corresponding level 2.

Thus, advantageously, the operator has the possibility, via the graphic interaction object 36, of dynamically controlling the display depth and the centering of the display on a selected central element.

Advantageously, the hierarchical display depiction is updated dynamically, without operator intervention, when the operator selects another hierarchical level as the central display level.

Advantageously, the operator may choose to focus on certain levels of information by selecting a display deactivation of one or more hierarchical levels.

FIG. 6 illustrates the main steps of a method for displaying elements from a hierarchical database with n levels according to one embodiment of the invention, implemented by the central processing unit 6 of the terminal 1.

The method is implemented following an initial display in a display window of elements of a database according to several hierarchical levels, and of an associated graphic interaction object as described above.

During an initial step, the method is placed on standby 80 while awaiting a new activation/deactivation command from an operator, via the displayed graphic interaction object.

When such a command is received, the method verifies, in step 82, whether the zone commanded by the operator corresponds to the central display level of the current display state.

If so, step 82 is followed by step 80 previously described while awaiting an operator command. Indeed, there is no display modification following a command related to the central level, the display state of which is blocked in the “activated” state and cannot be changed, as already described above.

Otherwise, step 82 is followed by a step 84 for obtaining the hierarchical level p corresponding to the selected zone.

As explained above, each activation/deactivation zone is associated with a hierarchical level of the database to be displayed.

Next, in step 86, it is verified whether the selected zone has a corresponding “activated” display state.

In case of positive response to the verification step 86, the hierarchical level p is filtered during a filtering step 88, therefore the elements of hierarchical level p are hidden. Links between the parent level of the displayed level p and the child level of the displayed level p previously displayed are calculated during a link calculation step 90.

In case of negative response to the verification step 86, this step is followed by a step 92 for selecting elements of the hierarchical level p to be displayed, in relation with the central element displayed in the current display state.

Steps 90 to 92 are followed by a step 94 for changing the visual indication associated with the activation/deactivation zone selected by the operator, to indicate the associated change in display state, going from an “activated” state to a “deactivated” state, or vice versa.

Next, during a display step 96, the hierarchical graph modified based on the respective steps 88, 90 or 92 is displayed. Thus, a new display state is achieved, which becomes the current display state.

Step 96 is followed by step 80 previously described.

FIG. 7 illustrates the main steps of a method for displaying a central element of a hierarchical database with n levels according to one embodiment of the invention, implemented by the central processing unit 6 of the terminal 1.

The method is implemented following an initial display in a display window of elements of a database according to several hierarchical levels, and of an associated graphic interaction object as described above.

During a first step 100, a command to select a central element of the displayed hierarchical graph is received, or a command to select a new central display level.

Following the reception of such a command, the selected hierarchical level or the hierarchical level to which the selected central element belongs is placed at the central level during an update step 102 of the central display level.

Next, an update 104 of the hierarchical graph is done. During this step, the display is centered on the central element and the central level, and the displayed levels are offset with respect to the central level. For example, if the previous display includes the display of three hierarchical levels, a parent level of the previous central level, the previous central level and a daughter level of the previous central level, the same display scheme is applied to display the hierarchical graph of the new selected central level.

Furthermore, if applicable, the icon depicting the selected central element is updated, as is the icon depicting the previous central element.

Furthermore, a visual indication associated with the selected central level is put into place.

The level indicator of the graphic interaction object is also moved relative to the central level selected during the following step 106. Thus, a complete update of the display is done, to obtain a hierarchical graph centered on a new selected central level and/or a new selected central element.

1. A display terminal for elements of a hierarchical database with n levels, at least some of the elements of the database belonging to a same hierarchical level having an association relationship, the terminal including at least two display parts wherein a first display part is intended to display a depiction by hierarchical levels of the elements of the database and a second display part is intended to display a graphic interaction object, having n display activation/deactivation zones, each display activation/deactivation zone corresponding to a hierarchical level in the first display part, the terminal including a level filtering module and a display rearrangement module,
said display activation/deactivation zones being accessible to an operator of the terminal to command the level filtering and display rearrangement modules, so as to obtain a selected display depiction of the database,
the terminal further including a selector for selecting a central display level, the display of the selected central display level not being able to be deactivated via said activation/deactivation zones.

2. The display terminal according to claim 1, wherein the graphic interaction object includes a displayed level indicator, accessible to the operator to modify the number of levels displayed around the central display level.

3. The display terminal according to claim 1, comprising means for selecting a central display element, and wherein the hierarchical level to which the central display element belongs is designated as central display level.

4. The display terminal according to claim 3, further comprising a third display part able to display attributes relative to said central display element.

5. The display terminal according to claim 1, wherein the display rearrangement module is able to update the displayed elements and the display of the graphic interaction object as a function of the central display level selected by the operator.

6. The display terminal according to claim 1, wherein the elements of the database are depicted in hierarchical graph form, elements of the same hierarchical level being depicted on a same level of said hierarchical graph, elements of a current hierarchical level being connected to one or several elements of the level above the current level and to one or several elements of the level below the current level.

7. The display terminal according to claim 1, wherein at least some display activation/deactivation zones of the graphic interaction object are associated with corresponding hierarchical sub-levels.

8. A method for displaying elements of a hierarchical database with n levels, at least some of the elements of the database belonging to a same hierarchical level having an association relationship, the terminal including at least two display parts, a first display part being intended to display a depiction by hierarchical levels of the elements of the database and a second display part being intended to display a graphic interaction object, having n display activation/deactivation zone, each zone corresponding to a hierarchical level in the first display part, the method comprising:
receiving a selection command of a central display level,
receiving an operator selection command of an activation/deactivation zone,
verifying the association of the selected activation/deactivation zone with the central display level,
in case of negative verification, obtaining a hierarchical level p associated with said selected activation/deactivation zone,
modifying the depiction by hierarchical levels of the database by filtering or adding the hierarchical level p associated with said selected activation/deactivation zone.

9. The method for displaying elements from a database according to claim 8, comprising, after the step for obtaining a hierarchical level:
verifying a display activation state associated with said selected activation/deactivation zone,
in case of activated state, filtering the displayed elements with hierarchical level p and calculating the links between the elements of a parent level of hierarchical level p and the elements of a child level of hierarchical level p,
in case of deactivated state, selecting elements of the hierarchical level p to be displayed.

10. The method for displaying elements from a database according to claim 9, further comprising a step for updating the display of the activation/deactivation zones for the graphic interaction object.

11. The method for displaying elements from a database according to claim 8, further comprising steps, implemented following the reception of a selection command for the central display level, of:
updating the depiction by hierarchical levels of the database elements, and
updating a displayed level indicator associated with the graphic interaction object as a function of the selected central display level.

12. The method for displaying elements from a database according to claim 8, further comprising:
receiving a selection command for a central display element,
selecting the hierarchical level to which the central display element selected as central display level belongs,
updating the depiction by hierarchical levels of the database elements as a function of the selected central display level, and
updating a displayed level indicator associated with the graphic interaction object as a function of the selected central display level.
